(19) United States
(12) Patent Application Publication
(10) Pub. No.: US 2010/0265536 A1
(43) Pub. Date: Oct. 21, 2010

(54) Image processing method and image processing device

(75) Inventor: Takuya Hiraki, Tokyo (JP)

Correspondence Address: POSZ LAW GROUP, PLC, 12040 SOUTH LAKES DRIVE, SUITE 101, RESTON, VA, 20191, US

(73) Assignee: Oki Data Corporation, Tokyo (JP)

(21) Appl. No.: 12/662,261

(22) Filed: Apr. 8, 2010

(30) Foreign Application Priority Data
Apr. 17, 2009 (JP) 2009-101161

(51) Int. Cl. G06F 3/12

(52) U.S. Cl. 358/1.15

(57) ABSTRACT

An image processing method for managing output jobs that are output to a plurality of logical devices includes: a storing step for storing the output job in a storing part for each plurality of logical devices; an output job managing step for managing the output job stored in the storing part; a grouped information selecting step for selecting grouped information for grouping the output job; and a display control step for displaying the output job stored in the storing part in a grouped manner based on the grouped information.

### CROSS REFERENCE

The present application is related to, claims priority from and incorporates by reference Japanese patent application number 2009-101161, filed on Apr. 17, 2009.

### TECHNOLOGY FIELD

The present application relates to an image processing method and an image processing device, and especially relates to a display method of a print job that is spooled on an operating system (hereafter, OS) and a print job display system.

### BACKGROUND

For example, as described in Japanese laid-open patent application publication 2008-299668, technology has been proposed, when print data such as a document is printed using the printer due to an order from an image processing device that is configured by a computer (for example, a personal computer, hereafter PC) or the like, print setting information such as number of copies and document size is set in advance to a virtual printer (logical printer) which is a software interface instead of a physical printer, and print data is printed according to the print setting information. The logical printer is a virtual printer that is set in order to refer per different print setting information from an OS. For example, a plurality of logical printers can be created with respect to one physical printer in the case when many users are sharing one physical printer or the like.

Generally, the print job that is spooled on the conventional OS is listed and displayed by managing per logical printer which is a software interface which connects the OS and the physical printer. Moreover, as described in Japanese laid-open patent application publication H07-334334, when dividing one print data and processing using a plurality of logical printers, technology has been proposed, that has a spool directory for spooling a divided print data that is processed by the logical printer and a spool check program for monitoring the spool directory, that obtains a print request order for the logical printer at the spool check program, and that prints the print data following the print request order by outputting the print data to the printer according to the information.

However, the conventional image processing method and the image processing device cannot display and manage per print job that is spooled on an OS per user or per physical printer that is used for printing even when using either one of the aforementioned methods.

An image processing method disclosed in the present application for managing output jobs that are output to a plurality of logical devices includes: a storing step for storing the output job in a storing part for each plurality of logical devices; an output job managing step for managing the output job stored in the storing part; a grouped information selecting step for selecting grouped information for grouping the output job; and a display control step for displaying the output job stored in the storing part in a grouped manner based on the grouped information.

An image processing device disclosed in the present application for managing output jobs that are output to a plurality of logical devices includes: a storing part that stores the output jobs for each plurality of logical devices; an output job managing part that manages the output jobs that are stored in the storing part; a grouped information selecting part that selects the grouped information for grouping the output jobs; and a display controlling part that displays the output jobs that are stored in the storing part in a grouped manner based on the grouped information.

According to the image processing method and image processing device of the present application, the output job that is output to the logical device is grouped per device that is a target to output or per owner of the output job or the like, and is displayed in a list. Therefore, the output jobs of a plurality logical devices that are output to the same device that is used for output can be managed by being displayed on the same list, or can be managed by being displayed on a list per the owner of the output job.

### BRIEF DESCRIPTION OF THE DRAWINGS

FIG. 1 is a schematic diagram illustrating an image forming device of a first embodiment of the present application.

FIG. 2 illustrates a print job display screen of the image processing device 1 of FIG. 1.

FIG. 3 illustrates an example of a menu for grouping of the print job display screen of FIG. 2.

FIG. 4 illustrates an example of an editing screen showing how to sort groups in FIG. 3.

FIG. 5 illustrates an example of a how to sort group detailed setting screen for editing a group in FIG. 4.

FIG. 6 illustrates an example of an edit group screen for editing how to sort group in FIG. 5.

FIG. 7 illustrates an edit group detailed setting screen.

FIG. 8 is a flow diagram illustrating a summary of processing of the image processing device of FIG. 1.

FIG. 9 is a flow diagram illustrating a process to obtain a print job display (S4) of FIG. 8.

FIG. 10 is a schematic diagram illustrating the image processing device of the second embodiment of the present application.

FIG. 11 illustrates an example of a print job display screen of the image processing device 1A of FIG. 10.

### DETAILED DESCRIPTION

The embodiments of the present application will be clear when reading the following explanation of the preferred embodiments with reference to the attached drawings. However, the drawings are only to use as a reference, and they do not limit the scope of the present application.

### First Embodiment

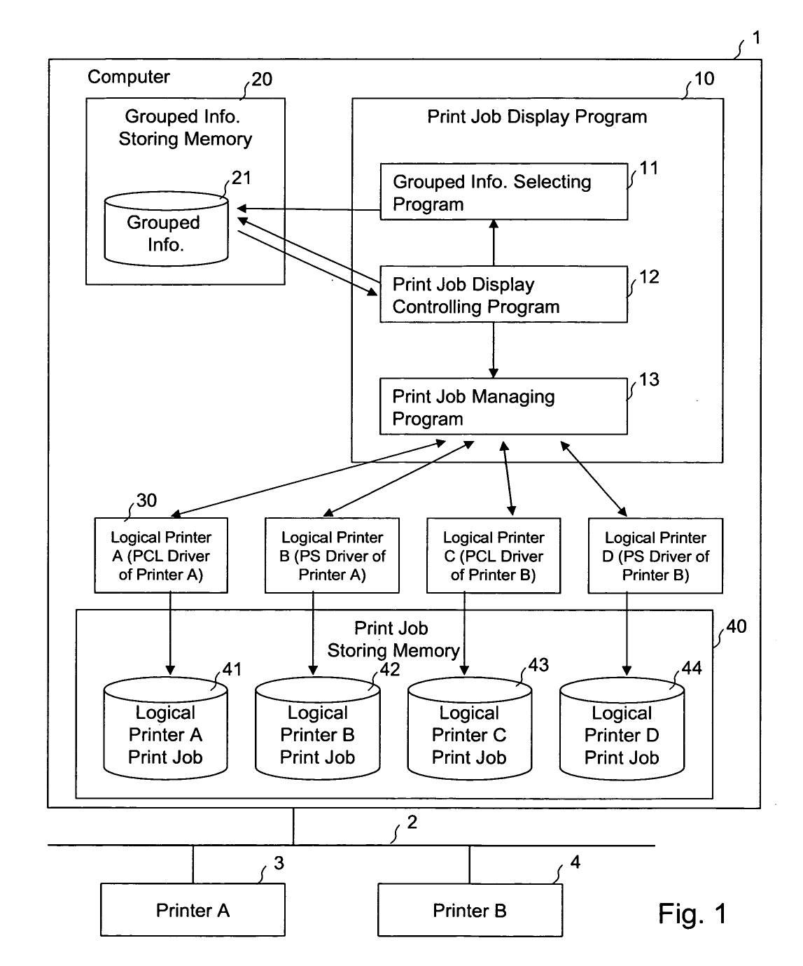

(Configuration of First Embodiment) FIG. 1 is a schematic diagram illustrating an image processing device of the first embodiment.

Moreover, hereafter, in order to avoid confusion of the terms of the logical printer and the physical printer, the logical printer is expressed as “logical printer” and the physical printer is expressed as “printer.”

An image processing device 1 of FIG. 1, for example, is configured of a central processing unit (hereafter, CPU) which has control and calculation functions, a plurality of memories that store information and a computer such as PC which has input/output machinery or that performs input/output of information, and is connected to a plurality of printers 3 and 4 via a network 2.

The image information processing device 1 has a memory (not shown in the figure) which contains a print job display program 10, a grouped information storing memory 20 which stores grouped information 21 which is used for the print job display program 10, a plurality of logical devices (for example, logical printers A, B, C and D that are the logical printers 30), and a storing part 40 (for example, a print job storing memory) or the like for storing output jobs (for example print jobs) that are related to each logical printer A-D.

The print job display program 10 has a grouped information selecting part 11 (for example, a grouped information selecting program), a display controlling part 12 (for example, a print job display controlling program) and an output job managing part 13 (for example, a print job managing program).

The grouped information selecting program 11 is a program to select the grouped information 21 which is a condition for grouping the print jobs at the print job display controlling program 12 by displaying a graphical user interface (hereafter GUI) which is a user interface for providing an intuitive operation by using computer graphics and a pointing device. A print job managing program 13 is a program to manage printing jobs that are related to the logical printers A, B, C and D that are installed in the image processing device 1. The print job display controlling program 12 uses the grouped information 21 that is selected at the grouped information selecting program 11, and displays the print jobs that are obtained at the output job managing program 13 in a grouped manner.

Among a plurality of logical printers 30, the logical printer A is a software interface which uses a printer control language and a printer driver (hereafter PCL driver) in order to print at a printer 3. The logical printer B is a software interface which uses a PostScript™ (Trademark of Adobe Systems Inc.) printer driver (hereafter PS driver). The logical printer C is a software interface which uses PCL driver in order to print at a printer 4. Moreover, the logical printer D is a software interface which uses the PS driver in order to print at the printer 4.

The print job storing memory 40 is a memory to store a logical printer A print job 41 that is a print job related to the logical printer A, a logical printer B print job 42 that is a print job related to the logical printer B, a logical printer C print job 43 that is a print job related to the logical printer C and a logical printer D print job 44 that is a print job related to the logical printer D.

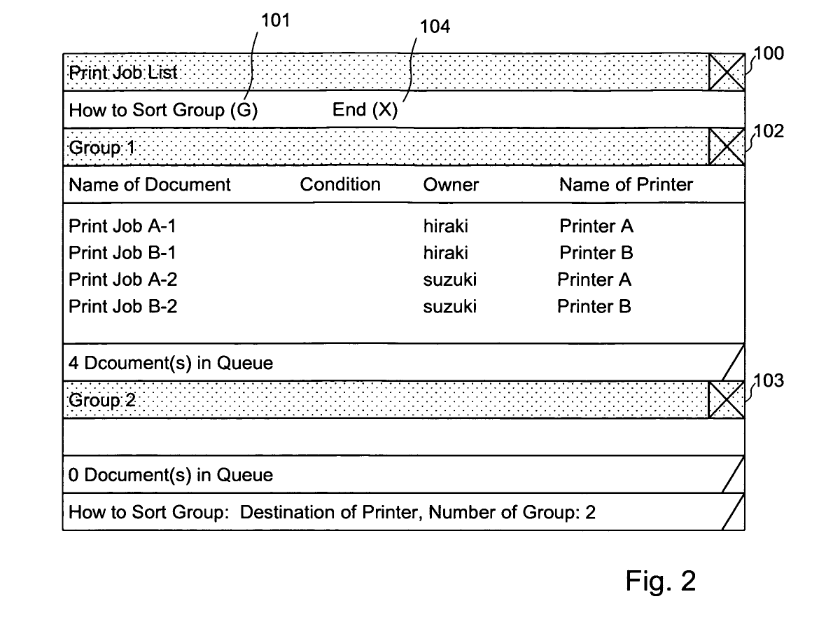

(Operation of First Embodiment) FIG. 2 illustrates a print job display screen of the image processing device 1 of FIG. 1.

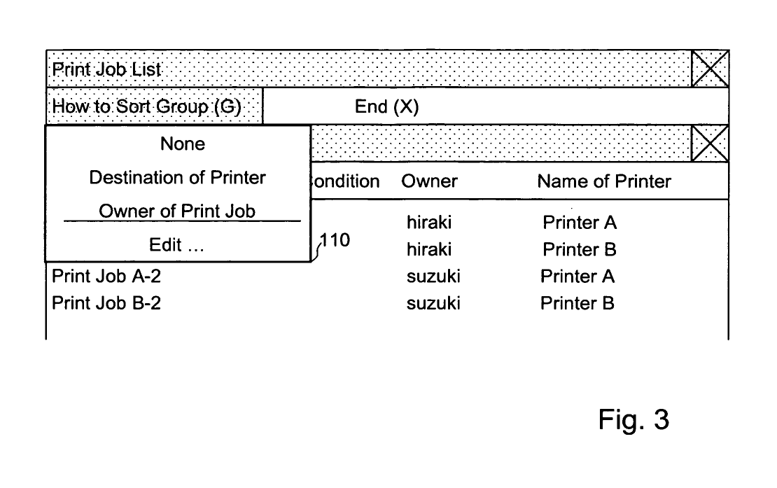

On a print job display screen 100, a how to sort group menu 101, print job lists 102 and 103, and an End (X) menu 104 or the like are displayed. When the user starts up the print job display program 10 which is installed in the image processing device 1, the print job display screen 100 is displayed. On the print job display screen 100, a name of document, a condition, an owner and a name of printer are displayed on the print job lists 102. For example, the owner of a print job A-1, “hiraki” and an owner of a print job A-2, “suzuki” of the logical printer A (PCL driver) which corresponds to the printer 3 are displayed. Moreover, the owner of a print job B-1, “hiraki” and an owner of a print job B-2, “suzuki” of the logical printer B (PS driver) which corresponds to the printer 3 are displayed. Further, the print job display program 10 also has an editing function or the like that is shown in later-described FIGS. 3-7.

FIG. 3 illustrates an example of a grouping menu of the print job display screen of FIG. 2. A grouping menu 110 is displayed as a window on the print job display screen 100 of FIG. 2.

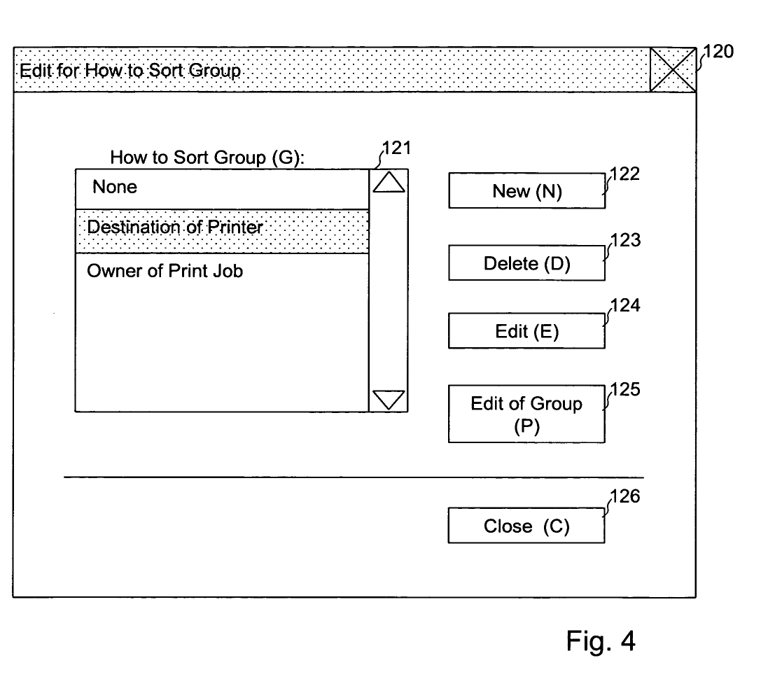

FIG. 4 illustrates an example of an editing screen showing how to sort groups in FIG. 3. When the edit button of the menu 100 of FIG. 3 is clicked (in other words, pressed), an edit how to sort group screen 120 (or edit screen) that is shown in FIG. 4 is displayed. On this edit screen120, for example, a menu for how to sort group (G) 121, a new button (N) 122, a delete button (D) 123, an edit button (E) 124, an edit of group button (P) 125, and a close button (C) 126 are displayed.

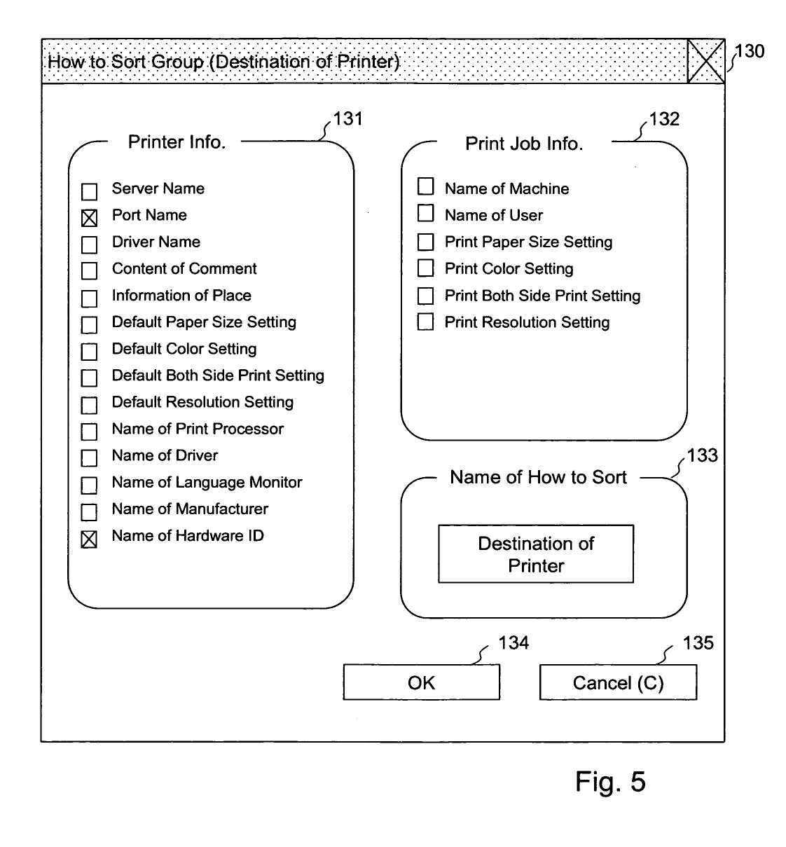

FIG. 5 illustrates an example of a detailed setting screen for the edit how to do sort groups screen in FIG. 4. When “destination of printer” on the how to sort group menu 121 of FIG. 4 is clicked, the how to sort group detailed setting screen 130 shown in FIG. 5 is displayed. On this detailed setting screen 130, for example, printer information 131, print job information 132, a name of how to sort 133, an OK button 134 and a cancel button (C) 135 are displayed.

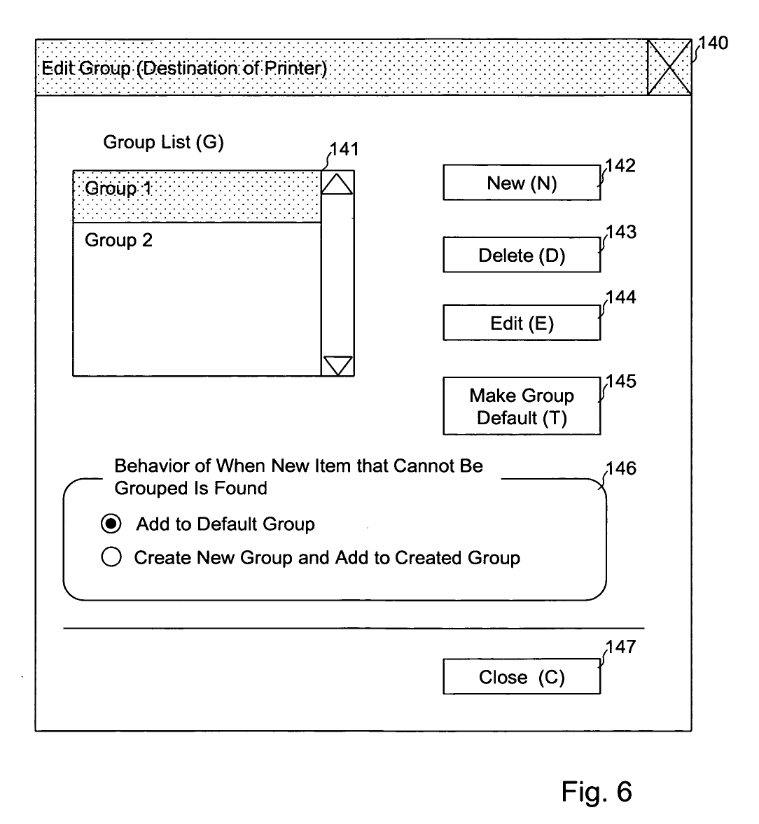

FIG. 6 illustrates an example of an edit group screen of editing the how to sort group screen in FIG. 5. When the how to sort group detailed setting screen 130 in FIG. 5 is displayed and the OK button 134 is clicked, the edit group screen 140 shown in FIG. 6 is displayed. On this edit group screen 140, for example, a group list (G) 141 (Group 1, Group 2), a new button (N) 142, a delete button (D) 143, an edit button (E) 144, a make group default button (T) 145, a “behavior when new item that cannot be grouped is found” button 146 and a close button (C) 147 are displayed.

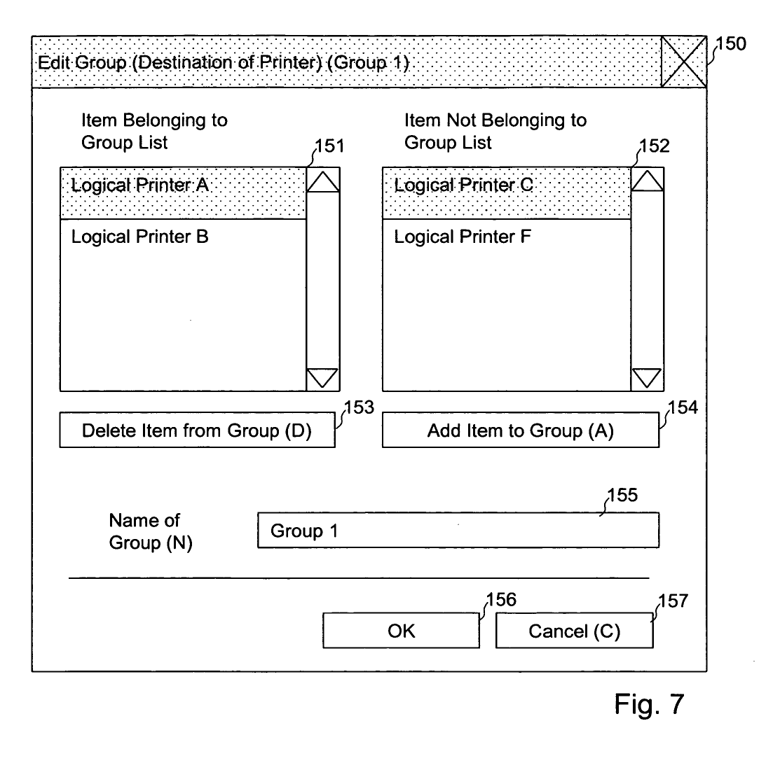

FIG. 7 illustrates an edit group detailed setting screen. When “Group 1” of the group list 141 of FIG. 6 is clicked, the edit group detailed setting screen 150 shown in FIG. 7 is displayed. On this edit group detailed setting screen 150, for example, an item belonging to group list 151, an item not belonging to group list 152, a delete item from group button (D) 153, an add item to group button (A) 154, a name of group field 155, an OK button 156 and a cancel button (C) 157 are displayed.

The operations (1)-(4) of the image processing device 1 of the present embodiment 1 are explained hereafter referring to FIGS. 2-7.

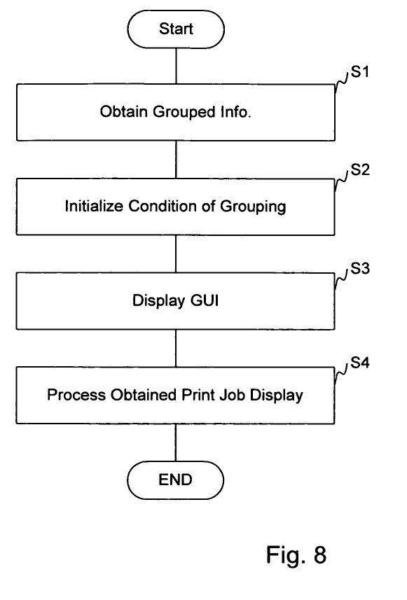

(1) Summary of Processing of Image Processing Device 1 (FIG. 8)

FIG. 8 is a flow diagram illustrating a summary of processing of the image processing device of FIG. 1.

Once the image processing device 1 starts operation and executes the print job display program 10 by the control of CPU which is not shown in the figure, the process obtains the grouped information 21 that is stored in the grouped information storing memory 20 (S1). Here, the grouped information 21 that is obtained is group 1 and group 2 that is grouped from the port names of the logical printers 30 (A, B, C and D) and from the hardware identifier (hereafter “Hardware ID”). The items of group 1 contain the logical printer A and the logical printer B, and the items of group 2 contain the logical printer C and the logical printer D.

Based on the grouped information 21 that is obtained at S1, after the condition of the grouping of the print job was initialized at the print job display controlling program 12 of the print job display program 10 (S2), the GUI is displayed (S3). The displayed GUI is the print job display screen 100 that is shown in FIG. 2.

When the GUI is displayed, the processing obtains the print job that is related to the logical printer 30 at the print job managing program 13, groups the print job based on the grouping condition that is initialized at S2, and displays the print job on the GUI that is displayed at S3 (S4). The print jobs that are grouped in group 1 are displayed on the print job list 102 of group 1 that is shown in FIG. 2, and the print jobs that are grouped in group 2 are displayed on the print job list 103 of group 2. This processing displays the latest information by repeating per constant interval. The details of the processing will be later explained.

When the GUI is completed, the end menu 104 of FIG. 2 is clicked. When the End menu 104 is clicked, the processing of S4 ends, and the print job display program ends.

(2) Operation of Obtained Pint Job Display Process of FIG. 8 (S4).

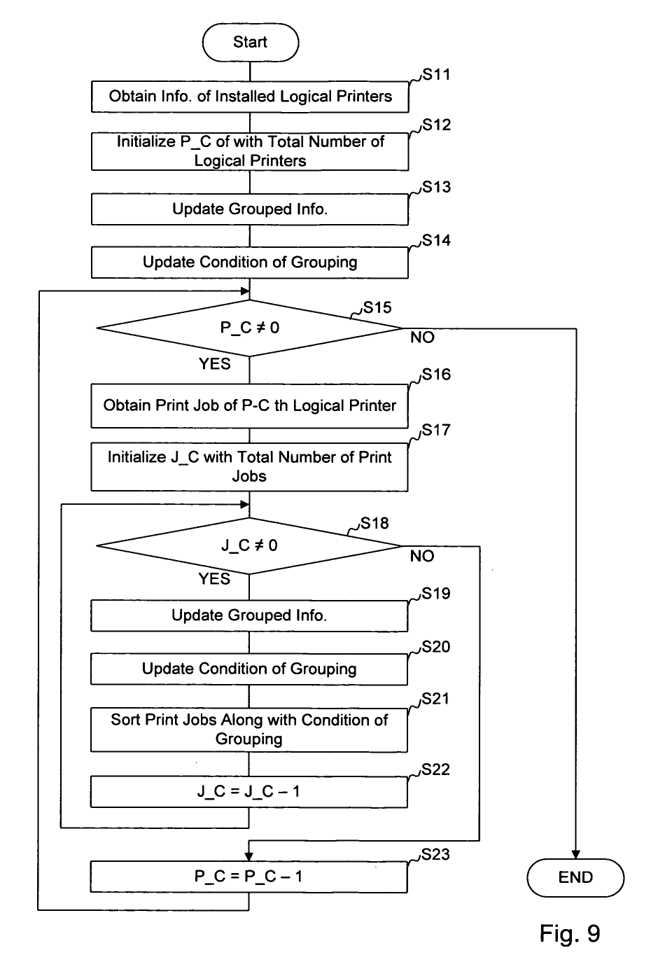

FIG. 9 is a flow diagram illustrating the obtained print job display process (S4) of FIG. 8.

When the obtained print job display processing (S4) of FIG. 8 is started, first of all, the image processing device 1 obtains the information of the logical printers 30 (A, B, C and D) that are installed in this image processing device 1 (S11). For example, the information of the logical printers 30 are obtained using Enum Printers function of Microsoft Windows™. At this point, as the total number of the logical printers 30 (A, B, C and D) that are installed is revealed, a parameter P_C is initialized with the total number of the logical printers 30 (A and B) (S12).

After the initialization, the process updates the grouped information 21 (S13). After the grouped information 21 is stored in the grouped information storing memory 20, this is performed in order to group the print jobs that are related to the logical printers 30 (A, B, C and D) that are installed in the image processing device 1. Here, the newly detected logical printer 30 is grouped based on the information that it is grouped with the port name and the hardware ID of the logical printers 30 (A, B, C and D) of the grouped information 21 that is stored in the grouped information storing memory 20.

However, when the information cannot be grouped into the existing groups, the process processes based on the setting of the “behavior when new item that cannot be grouped is found” button 146. At the “behavior when new item that cannot be grouped is found” button 146 of FIG. 6, when the add to default group (initial setting value) button is selected, the information is grouped to “Group 1” which is the item being checked on the group list 141. When “create new group and add to created group” is selected, the group 3 is created as a new group, and the logical printers 30 that are the new items are grouped.

After initialization, at S13, the condition of the grouping that is performed at the print job display controlling program 12 is updated with the updated grouped information 21(S14).

The processing after this step (S15-S23) is repeated for the number of the logical printers 30. Therefore, the process checks whether the parameter P_C is 0 (S15). When the parameter P_C is 0 (NO), the obtained print job display process ends, and when the parameter P_C is not 0 (YES), the process proceeds to S16.

At S16, the information of the print job that is related to the P_C th logical printer 30 is obtained. For example, in Microsoft Windows™, the information is obtained using Enum Jobs function. Here, as the total number of the print job that is related the P_C th logical printer 30 is revealed, a parameter J_C is initialized with the total number of the print jobs that are related to the P_C th logical printer 30 (S17).

The next processing (S18-S22) is repeated for the number of the print jobs that are related to the P_C th logical printer 30. Therefore, the process confirms whether or not the parameter J_C is 0 (S18). When the parameter J_C is 0 (NO), the process deducts the value of the parameter P_C by 1 (minus) and processes S15 (S23), and when the parameter J_C is not 0 (YES), the process proceeds to S19.

At S19, the process updates the grouped information 21. This is performed in order to group the item when the print job of the J_C th parameter becomes an item for a new grouping that is not available in the grouped information 21 that is stored in the grouped information storing memory 20. Here, the item that is newly detected is the information related to the print job such as an owner (user name) of the print job, and confirmation processing is performed when this kind of information is being selected as a grouping condition. However, when it cannot be grouped into the existing groups, this is grouped similar to S13.

The condition of grouping that is performed at the print job display controlling program 12 is updated with the grouped information that is updated at S19 (S20), and the process proceeds to S21. At S21, the print job is sorted along with the condition of the grouping. In the case when the print job is related to the logical printer A, the item of the print job list 102 of the group 1 in FIG. 2 is added. After this, the process deducts the value of the parameter J_C by 1 and performs the processing of S18 (S22). According to the above operations, the obtained print job displaying process (S4) is performed.

(3) Operations of Adding, Deleting and Editing Processings of Grouped Information 21

With reference to FIGS. 2-7, the operations of the adding processing, the deleting processing and editing processing of the grouped information 21 that are performed at the grouped information selecting program 11 are explained.

The type of grouping (how to sort groups) can be changed by selecting one of the lists that are displayed on the menu 110 of FIG. 3 that is displayed by selecting the how to sort group menu 101 of the print job display screen 100 of FIG. 2.

When the editing item of the menu 110 of FIG. 3 is selected, the edit how to sort group screen 120 of FIG. 4 is displayed in order to edit the contents of the items that are listed above and to add or to delete items to the lists. The items displayed on the menu 110 are displayed as a selectable list on the how to sort group menu 121 of the edit how to sort group screen 120. In order to delete the item that is displayed on the how to sort group menu 121, the user selects the item to be deleted, and clicks the delete button 123. When a new item is added to the how to sort group menu 121, the user clicks the New button 122. When the user desires to edit the content of the item that is displayed on the list for the how to sort group menu 121, the user selects the item to be edited, and click the Edit button 124.

When the New button 122 or the Edit button 124 is clicked, the how to sort group detailed setting screen 130 of FIG. 5 is displayed. At the how to sort group detailed setting screen 130, information 131 for the printers 3 and 4 that is obtained from the logical printers 30, the print job information 132 that can be obtained from the print job and the name of how to sort 133 for setting a name of the item to be displayed on the how to sort group menu 121 are displayed so that they are settable. The user selects the item that becomes a condition for grouping from the information 131 of the printers 3 and 4 and the printing job information 132. In order to make the selected content effective, they click the OK button 134, and in order to invalidate, the user clicks the cancel button 135.

When the OK button 134 or the cancel button 135 is clicked, the how to sort group detailed setting screen 130 ends. Then, when the OK button 134 is clicked, and when the how to sort group detailed setting screen 130 is displayed by the New button 122, the item is added to the how to sort group menu 121. When the detailed setting screen 130 is displayed by the edit button 124, the content of the selected item at the how to sort group menu 121 is updated.

When the edit of group button 125 in FIG. 4 is clicked, the edit group screen 140 of FIG. 6 is displayed in order to edit the group of the item selected at the how to sort group menu 121. The group list 141 displays the group that is created with respect to the item selected at the how to sort group menu 121 of FIG. 4. Among the group displayed here, a default group can be set. Further, the selected group can be set to be a default group by selecting the group to make it the default group and clicking the make group default button 145. In the default group, a check mark is applied on the group item name that is displayed on the group list 141.

The default group, in a setting related to the “behavior when new item that cannot be grouped is found,” behaves to add a new item that cannot be grouped into the group that is selected as the default group when “add to default group” is selected as the “behavior when new item that cannot be grouped is found” button 146. At the “behavior when new item that cannot be grouped is found” button 146, when “create new group and add to created group” is selected, the process behaves to create a new group item and to add a new item that cannot be grouped into the created groups without adding it the default group.

In order to delete the items that will be displayed on the group list 141 of FIG. 6, the user selects the item desired to be deleted, and clicks the delete button 143. When new item is added to the group list 141, the user clicks the new button 142. When editing the content of the items displayed on the group list 141, the user selects the item to be edited and clicks the edit button 144. When the new button 142 or the edit button 144 is clicked, the edit group detailed setting screen 150 of FIG. 7 is displayed.

At the edit group detailed setting screen 150 of FIG. 7, the items that belong to the group are displayed on the item belonging to group list 151, and the items that do not belong to the group is displayed on the item not belonging to group list 152. In order to delete the item that is displayed on the list for the item belonging to group list 151 from the group, the user selects the item to be deleted at the item belonging to group list 151, and clicks the delete item from group button 153. The deleted item will be added to the item not belonging to group list 152. In order to add the item that is displayed on the list for the item not belonging to group list 152 to the groups, the user selects the item to be added at the item not belonging to group list 152, and clicks the add item to group button 154. The added item is then deleted from the item not belonging to group list 152. The name of the group which is being edited can be changed at the name of group field 155.

When the editing of the group is completed, the user presses/clicks the OK button 156 to end the edit group detailed setting screen 150 of FIG. 7. When cancelling the editing of the group, the user clicks the cancel button 157 and ends the edit group detailed setting screen 150. When the edit group detailed setting screen 150 is ended by clicking the OK button 156, and when the edit group detailed setting screen 150 is displayed by clicking the new button 142 of FIG. 6, an item is added to the group list 141. And when the edit group detailed setting screen 150 is displayed by clicking the edit button 144 of FIG. 6, the content of the item that is selected at the group list 141 is updated. According to the above operations, the adding processing, deleting processing and editing processing of the grouped information 21 are performed.

(4) Operation of Print Job Controlling Process

The operation of the control processing of the print job that is displayed on the print job display screen 100 of FIG. 2 is explained.

The control of the print job that is displayed on the print job display screen 100 is performed using, for example, a Set Job function of Microsoft Windows™. By using this function, cancel, hold and delete of the print job can be performed.

(Effect of First Embodiment) According to the first embodiment, the print jobs that are output to the logical printers 30 (A, B, C and D) that are installed in the image processing device 1 are displayed in a list by grouping (in a grouped manner) per the printers 3 and 4 that are targets to output or per the owner of the print job. Therefore, not only print jobs per logical printers 30 (A, B, C and D) can be displayed, but also print jobs of a plurality of the logical printers 30 (A, B, C and D) that are output to the same printers 3 and 4 can be displayed on the same list. Also, print jobs can be managed by being displayed on the list per owner of the print job.

### Second Embodiment

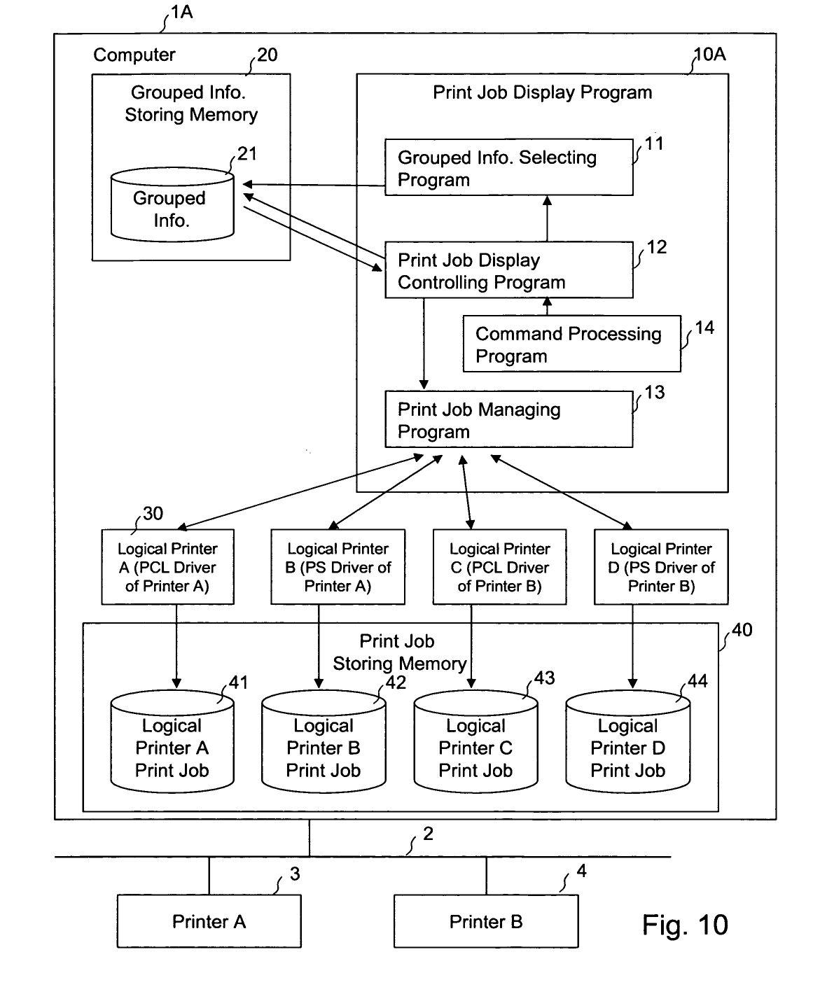

(Configuration of Second Embodiment) FIG. 10 is a schematic diagram illustrating the image processing device of the second embodiment of the present application, and the same numbers are applied to the elements that are common with the elements in FIG. 1 showing the first embodiment.

The image processing device 1A of the second embodiment has a print job display program 10A that is different from the print job display program 10 of the image processing device 1 of the first embodiment. The command processing program 14 is newly added with respect to the print job display program 10 of the first embodiment at the print job display program 10A of the second embodiment. The command processing program 14 is a component of the print job display program 10A, and is a program to process the parameter which is designated when this print job display program 10A is activated. In short, the print job display program 10A starts up by this command processing program 14. Other configurations are the same as the first embodiment.

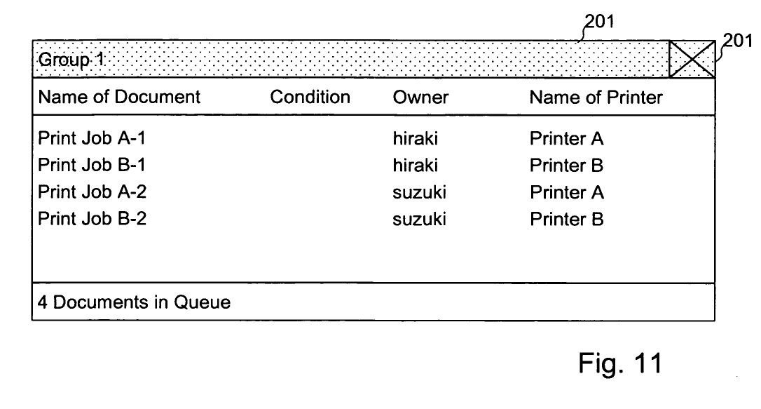

(Operation of Second Embodiment) FIG. 11 illustrates an example of a print job display screen of the image processing device 1A of FIG. 10, and corresponds to the print job display screen of FIG. 2 which shows the first embodiment.

At a print job display screen 200 of FIG. 11, only a print job list 201 of the group 1 is displayed. On the print job list 201, there are two types of owners (user names) displayed, “hiraki” and “suzuki”. This kind of processing normally can be done with the logical printer 30 that is set to share. The characteristic of FIG. 11 is that the print jobs of the two different kinds of logical printers, the physical printer A and the physical printer B, are displayed on the one print job list 201.

At the second embodiment, when the print job display program 10A is activated, the parameter is designated. There are two parameters. The first parameter is an ID to identify how to sort groups, and the second parameter is an ID to identify one of the groups that are owned by the group that is designated at the first parameter. Hereafter, the example of the command which activates the print job display program 10A is shown.

(Example) Program.exe, “destination of a printer,” “group 1.”

Program.exe of this command is an example of the name of the print job display program 10A, and designates the destination of the printer as the first parameter, and designates the group 1 as the second parameter. The print job display screen 200 of the print job display program 10A that is activated by this command is shown in FIG. 11.

In order to provide the display as shown in FIG. 11, the print job display program 10A analyzes the activation command at the command processing program 14 at the time of activation. It confirms existence or nonexistence of the parameter. When there is no parameter, the print job display screen 100 is displayed that is shown in FIG. 2 as in the first embodiment. When there is a parameter, the process obtains the parameter, and specifies how to sort groups according to the obtained parameter, and specifies the group that is designated by the parameter among the groups that are owned by the specified group. Based on the specified information, the logical printer A and the logical printer B are obtained as the items belonging to the group from the grouped information 21 that is stored in the grouped information stored memory 20 (S1 of FIG. 8).

The condition for grouping is initialized based on the how to sort obtained groups, one group among the groups that belongs to the how to sort group and the item which belongs to the group (S2 of FIG. 8). The print job that is output to the logical printer A and the logical printer B becomes a condition of grouping the group 1. Subsequently, the GUI is displayed (S3 of FIG. 8). The displayed GUI only has the print job list 201 of the group 1 in FIG. 11.

A difference of the operation of the obtained print job displaying process (S4 of FIG. 8) compared to the first embodiment is that the process performs display processing of the group other than the designated condition at S21 of the flow diagram of FIG. 9, and the print job is added to the print job list 201 of the group 1 only with the designated condition. Other than this part, the operations are similar to the first embodiment.

Moreover, when there is no parameter in the command which activates the print job display program 10A, the operation will be the same as the first embodiment.

(Effect of Second Embodiment) According to the second embodiment, the print job of the desired group can be displayed and controlled without displaying all of the grouped print jobs of the entire groups. By doing this, management becomes easy.

(Modified Embodiments) The present application is not limited to the above-mentioned first and second embodiments, and various kinds of utility forms or modifications are possible. As for this kind of utility forms or modification examples, the following (a) and (b) are suggested.

(a) The image processing devices 1 and 1 A of FIGS. 1 and 10 can be modified to other configurations such as adding functions other than shown in the figures. Moreover, the image processing method of the image processing devices 1 and 1A of FIGS. 1 and 10 can be modified to a processing method other than shown in the figures.

(b) In the first and second embodiments, the logical printers 30 (A, B, C and D) that are the software interface for outputting to the printers 3 and 4, and the print jobs that are output related to the logical printers 30 (A, B, C and D) are explained. For example, the present application can be adopted to a logical facsimile (hereafter FAX) that is a software interface to output with respect to a FAX function that is provided with a multi function printer (hereafter MFP), and an image processing device that displays fax job or the like that is output related to the logical FAX and an image processing method, and the same function effect as described above can be obtained.

What is claimed is:

1. An image processing method for managing output jobs that are output to a plurality of logical devices, comprising:
a storing step for storing the output job in a storing part for each plurality of logical devices;
an output job managing step for managing the output job stored in the storing part;
a grouped information selecting step for selecting grouped information for grouping the output job; and
a display control step for displaying the output job stored in the storing part in a grouped manner based on the grouped information.

2. The image processing method of claim 1, wherein
the logical device is a logical printer;
the output job managing step is processed by a central processing unit (CPU) according to a print job managing program; and
the grouped information selecting step is processed by the CPU according to a grouped information selecting program;
the display control step is processed by the CPU according to a print job display controlling program.

3. The image processing method of claim 2, wherein the image processing method is initiated by a command processing program that is executed by the CPU.

4. An image processing device for managing output jobs that are output to a plurality of logical devices, comprising:
a storing part that stores the output jobs for each plurality of logical devices;
an output job managing part that manages the output jobs that are stored in the storing part;
a grouped information selecting part that selects the grouped information for grouping the output jobs; and
a display controlling part that displays the output jobs that are stored in the storing part in a grouped manner based on the grouped information.

5. The image processing device of claim 4, wherein
the logical device is a logical printer;
the storing part is a print job storing memory;
the output job managing part includes a print job managing program that is executed by a central processing unit (CPU);
the grouped information selecting part includes a grouped information selecting program that is executed by the CPU; and
the display controlling part includes a print job display controlling program that is executed by the CPU.

6. The image processing device of claim 5, wherein the image processing device is initiated by a command processing program that is executed by the CPU.

7. The image processing method of claim 1, wherein the output jobs to the plurality of logical devices that are output to a same physical device being grouped on a display together separate from output jobs that are output to a different physical device.

8. The image processing device of claim 4, wherein the output jobs to the plurality of logical devices that are output to a same physical device being grouped on a display together separate from output jobs that are output to a different physical device.
